(19) United States
(12) Patent Application Publication
(10) Pub. No.: US 2016/0167001 A1
(43) Pub. Date: Jun. 16, 2016

(54) COMPOSITIONS COMPRISING OXIDIZED STARCH AND PROCESSES FOR MAKING THE COMPOSITIONS

(71) Applicant: Rivertop Renewables, Inc., Missoula, MT (US)

(72) Inventors: Kelly Barton, Hamilton, MT (US); Tyler Smith, Missoula, MT (US); Donald E. Kiely, Missoula, MT (US)

(21) Appl. No.: 14/938,890

(22) Filed: Nov. 12, 2015

Related U.S. Application Data
(60) Provisional application No. 62/081,086, filed on Nov. 18, 2014.

(51) Int. Cl. B01F 17/00; C11D 3/22

(52) U.S. Cl. CPC B01F 17/0028; C11D 3/223

(57) ABSTRACT

Compositions and processes for making the compositions are provided. The compositions can include at least one oxidized starch. The processes provided to make the compositions can include the use of a co-catalyst or the use of a secondary oxidation step. The compositions can be used as dispersing agents in detergents and cleaning compositions, in paper and textile sizing agents, and as thickening agents in foods.

### CROSS-REFERENCE TO RELATED APPLICATIONS

This application claims priority to U.S. Provisional Patent Application No. 62/081,086, filed Nov. 18, 2014, the entire contents of which are incorporated by reference herein.

### TECHNICAL FIELD

This disclosure relates to compositions comprising oxidized starch and processes for making the compositions.

### BACKGROUND

Hydroxycarboxylic acids offer significant economic potential as carbon based chemical building blocks for the chemical industry, as safe additives or components of products used in pharmaceutical preparations and food products, and as structural components of biodegradable polymers, if they can be effectively produced on an industrial scale.

Starch is a carbohydrate consisting of a large number of glucose units joined by glycosidic bonds. This polysaccharide is produced by most green plants as an energy store. It is the most common carbohydrate in human diets and is contained in large amounts in such staple foods as potatoes, wheat, corn, rice, and cassava.

Starches, when oxidized, form oxidized starches possessing hydroxycarboxylic acids, and may be useful in a variety of applications. Oxidized starches may be used in many industrial applications, such as the paper, textile, laundry finishing, building materials, and food industries. Oxidized starches may be particularly useful as dispersing agents in detergents and cleaning compositions, in paper and textile sizing agents, and as thickening agents in foods. Accordingly, there exists a need for improved oxidation processes of starches that is safe, economical and efficient for conversion into their corresponding acids while giving control over molecular weight and degree of substitution.

### SUMMARY

In one aspect, disclosed is a composition comprising at least one oxidized starch, wherein at least 70% of the oxidized starch has a molecular weight greater than or equal to 2000 Daltons and a degree of carboxylation of at least 0.5 mole acid/mole glucose.

In another aspect, disclosed is a process of preparing a composition comprising at least one oxidized starch, wherein at least 70% of the oxidized starch has a molecular weight greater than or equal to 2000 Daltons and a degree of carboxylation of at least 0.5 mole acid/mole glucose, the process comprising the steps of:

a. selecting a starch suitable for nitric acid oxidation, wherein the starch is selected from the group consisting of amylose, high amylose corn starch, amylopectin, dent corn starch, potato starch, maltodextrins and mixtures thereof;

b. combining the starch and an aqueous solution of nitric acid to form a starch/nitric acid reaction mixture; wherein the molar ratio of nitric acid to glucose unit of the starch is about 2:1;

c. maintaining a temperature greater than 50° C. but no greater than 65° C., controlling a positive pressure of oxygen, and controlling agitation of the starch/nitric acid reaction mixture; and

d. removing a portion of the nitric acid from the reaction mixture to give a composition comprising at least one oxidized starch, wherein at least 70% of the oxidized starch has a molecular weight greater than or equal to 2000 Daltons and a degree of carboxylation of at least 0.5 mole acid/mole glucose.

In another aspect, disclosed is a process of preparing a composition comprising at least one oxidized starch, wherein at least 70% of the oxidized starch has a molecular weight greater than or equal to 2000 Daltons and a degree of carboxylation of at least 0.5 mole acid/mole glucose, the process comprising the steps of:

a. selecting a starch suitable for nitric acid oxidation, wherein the starch is selected from the group consisting of amylose, high amylose corn starch, amylopectin, dent corn starch, potato starch, maltodextrins, and mixtures thereof;

b. combining the starch, an aqueous solution of nitric acid and at least one co-catalyst to form a starch/nitric acid reaction mixture; wherein the molar ratio of nitric acid to glucose unit of the starch is about 2:1;

c. maintaining a temperature greater than 50° C. but no greater than 65° C., controlling a positive pressure of oxygen, and controlling agitation of the starch/nitric acid reaction mixture; and

d. removing a portion of the nitric acid from the reaction mixture to give a composition comprising at least one oxidized starch, wherein at least 70% of the oxidized starch has a molecular weight greater than or equal to 2000 Daltons and a degree of carboxylation of at least 0.5 mole acid/mole glucose.

In another aspect, disclosed is a process of preparing a composition comprising at least one oxidized starch, wherein at least 70% of the oxidized starch has a molecular weight greater than or equal to 2000 Daltons and a degree of carboxylation of at least 1 mole acid/mole glucose and further wherein the composition is stable at a pH greater than 7, the process comprising the steps of:

a. selecting a starch suitable for nitric acid oxidation, wherein the starch is selected from the group consisting of amylose, high amylose corn starch, amylopectin, dent corn starch, potato starch, maltodextrins, and mixtures thereof;

b. combining the starch and an aqueous solution of nitric acid to form a starch/nitric acid reaction mixture; wherein the molar ratio of nitric acid to glucose unit of the starch is about 2:1;

c. maintaining a temperature greater than 50° C. but no greater than 65° C., controlling a positive pressure of oxygen, and controlling agitation of the starch/nitric acid reaction mixture;

d. removing a portion of the nitric acid from the reaction mixture to give a composition comprising at least one oxidized starch, wherein at least 70% of the oxidized starch has a molecular weight greater than or equal to about 2000 Daltons and a degree of carboxylation of at least 1 mole acid/mole glucose; and

e. combining the composition of step d and at least one oxidant to form a further composition comprising at least one oxidized starch; wherein the molar ratio of the oxidant to glucose unit of the starch is about 1:1 to about 5:1; wherein at least 70% of the oxidized starch has a molecular weight greater than or equal to 2000 Daltons and a degree of carboxylation of at least 1 mole acid/mole glucose and further wherein the composition is stable at a pH greater than 7.

The compositions, methods, and processes are further described herein.

### BRIEF DESCRIPTION OF THE DRAWINGS

FIG. 1 is a graph depicting the stability of exemplary high and low amylose containing compositions.

FIG. 2 is a graph depicting the stability of exemplary oxidized potato starch compositions made by a process with or without a vanadium co-catalyst.

FIG. 3 is a graph depicting the stability of exemplary oxidized dent corn starch compositions made by a process with or without a secondary oxidation step.

### DETAILED DESCRIPTION

The present disclosure relates to compositions, methods for preparing the compositions, and methods for using the compositions. The disclosed compositions include at least one oxidized starch. Oxidized starches are useful materials because they contain carboxylic acid groups that may be converted to a salt form, which may then be useful due to their ability to act as chelating agents and sequester a variety of metals in a variety of applications.

The present disclosure relates to a safe, efficient and economical oxidation processes for oxidizing starches into their corresponding organic acid products. The processes provide an efficient and unexpected method of oxidizing starches at elevated temperature (50-65° C.) to yield compositions comprising at least one oxidized starch that maintains a high fraction of the starch with a higher molecular weight (greater than or equal to 2000 Daltons). The processes produce the composition with improved stability at basic pH. In particular, the processes improve the stability of compositions with high amylose content up to 33% as compared to compositions with low amylose content after two weeks at basic pH. The processes described may include the use of a co-catalyst, resulting in as much as a 40% improvement in the stability of the compositions as compared to those prepared without a co-catalyst, after two weeks at basic pH. The processes described may include the use of a second oxidation step, resulting in as much as a 47% improvement in the stability of the compositions as compared to those prepared without the use of a second oxidation step, after two weeks at basic pH.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

The terms “stable” and “stability”, as used herein, refer to a weight percentage of the oxidized starch that maintains a molecular weight at or above a specified molecular weight under specified conditions. In one example, the composition may be stable at pH 10. This means that, at pH 10, a certain weight percentage of the oxidized starch has a molecular weight above a specified value and is resistant to degradation reactions that produce molecular weight fragments below the specified molecular weight over time. Degrees of stability of different compositions may also be compared in the present disclosure. For example, a composition which retains 80% of its oxidized starch with molecular weight greater than 2000 Daltons after exposure to basic pH is more stable than a composition which retains 50% of its oxidized starch greater than 2000 Daltons. Values defining the limits of stable compositions are defined further below.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. OXIDIZED STARCH COMPOSITION

Disclosed is a composition. The composition includes at least one oxidized starch. The composition may also include one or more additional components. The additional components may be present in the composition to improve any desirable properties of the composition, or processes by which the composition may be made. The composition may be free of nitric acid. The composition may be essentially free of nitric acid. The composition may comprise no nitric acid.

Oxidized starches are useful materials because they contain carboxylic acid groups that may be converted to a salt form, which may be useful due to their ability to act as chelating agents and sequester a variety of metals in a variety of applications. Accordingly, the compositions may be useful as dispersing agents in detergents and cleaning compositions, in paper and textile sizing agents, and as thickening agents in foods.

The oxidized starch may be oxidized amylose, oxidized high amylose corn starches, oxidized amylopectin, oxidized corn starch, oxidized potato starch, maltodextrins, oxidized pea starch, or mixtures thereof.

Generally, starch is made up of amylose and amylopectin. Amylose is made up of 30-3,000 glucose units connected through α(1→4) bonds. Amylopectin is a larger and more varied structure of 2,000-200,000 glucose units with branching through α(1→6) bonds every 24-30 glucose units. Different species of starch are characterized by their different percentages of amylose. For example, dent corn starch has about 20% amylose, potato starch has about 25% amylose, and pea starch has about 35% amylose. Some species of corn starch are known to contain higher amounts of amylose. High amylose corn starches contain about 50-70% amylose, or 2-3 times the amount found in common, dent corn starch. The high amylose starch described herein may contain 70% amylose.

Maltodextrins are corn starches that have been broken down, usually by acid hydrolysis. They are classified on the basis of dextrose equivalents (DE), ranging from 3-20. When a starch has a lower DE value, this corresponds to a less broken down starch and a larger polymer chain. As the DE number increases the solubility also increases. Maltodextrins may be useful because they are more soluble that native starch.

At least 60%, at least 65%, at least 70%, at least 75%, at least 80%, at least 85%, at least 90%, at least 95%, or at least 99%, by weight, of the oxidized starch in the composition has a molecular weight greater than or equal to 2000 Daltons. At least 60%, at least 65%, at least 70%, at least 75%, at least 80%, at least 85%, at least 90%, at least 95%, or at least 99%, by weight, of the oxidized starch in the composition has a molecular weight greater than or equal to 1800 Daltons. At least 60%, at least 65%, at least 70%, at least 75%, at least 80%, at least 85%, at least 90%, at least 95%, or at least 99%, by weight, of the oxidized starch in the composition has a molecular weight greater than or equal to 2200 Daltons.

The oxidized starch in the composition has a degree of carboxylation of at least 0.5 mole acid/mole glucose, at least 0.6 mole acid/mole glucose, at least 0.7 mole acid/mole glucose, at least 0.8 mole acid/mole glucose, at least 0.9 mole acid/mole glucose, at least 1.0 mole acid/mole glucose, at least 1.1 mole acid/mole glucose, at least 1.2 mole acid/mole glucose, at least 1.3 mole acid/mole glucose, at least 1.4 mole acid/mole glucose, at least 1.5 mole acid/mole glucose, at least 1.6 mole acid/mole glucose, at least 1.7 mole acid/mole glucose, at least 1.8 mole acid/mole glucose, at least 1.9 mole acid/mole glucose, or at least 2.0 mole acid/mole glucose.

The composition may be stable at pH 8 to pH 12, pH 9 to pH 12, pH 10 to pH 12, pH 11 to pH 12, pH 8 to pH 10, pH 8 to pH 9, pH 8 to pH 11, pH 9 to pH 12, pH 9 to pH 11, pH 9 to pH 10, pH 10 to pH 12, pH 10 to pH 11, or pH 11 to pH 12. The composition may be stable at pH greater than 7, greater than 8, greater than 9, greater than 10, greater than 11, or greater than 12. The composition may be stable at pH 8, pH 9, pH 10, pH 11, or pH 12. The composition may be stable for at least 1 week, at least 2 weeks, at least 3 weeks, or at least 4 weeks. The composition may be stable at pH 8, pH 9, pH 10, pH 11, or pH 12 for at least 1 week, at least 2 weeks, at least 3 weeks, or at least 4 weeks. The composition may be stable at pH greater than 7, greater than 8, greater than 9, greater than 10, or greater than 11 for at least 1 week, at least 2 weeks, at least 3 weeks, or at least 4 weeks. To be defined as stable, the weight percent of the oxidized starch of the composition having a molecular weight greater than about 2000 Daltons is greater than 60%, greater than 65%, greater than 70%, greater than 75%, greater than 80%, greater than 85%, or greater than 90%.

In an embodiment, the composition comprises oxidized high amylose starch and is stable at pH 10 for at least 2 weeks. In another embodiment, the composition comprises oxidized high amylose starch and is stable at pH greater than 7 for at least 2 weeks. In another embodiment, the composition comprises oxidized potato starch and is stable at pH 10 for at least 2 weeks. In another embodiment, the composition comprises oxidized potato starch and is stable at pH greater than 7 for at least 2 weeks. In another embodiment, the composition comprises oxidized dent corn starch and is stable at pH 10 for at least 2 weeks. In another embodiment, the composition comprises oxidized dent corn starch and is stable at pH greater than 7 for at least 2 weeks.

### 3. PROCESSES FOR MAKING THE COMPOSITION

The composition may be manufactured by a process employing nitric acid as an oxidant to provide the oxidized starch. Described herein are three processes that may be employed to provide the composition of the present disclosure.

A. Process I: Oxidation of Starch with Nitric Acid

The process for the oxidation of starch with nitric acid can provide the composition described above. The process may produce the composition with improved stability at basic pH. This process is advantageous for the oxidation of starches with high amylose content versus starches with low amylose content wherein both starches have similar degrees of oxidation. As such, compositions of the present disclosure comprising oxidized high amylose corn starch have unexpectedly greater stability at basic pH than compositions comprising oxidized low amylose corn starch. One of skill would expect the amount of amylose in a starch to influence the degree of oxidation due to steric considerations. However, unexpectedly, differing starches with the same degree of oxidation are demonstrated to exhibit differing stabilities under basic pH conditions.

In particular, the process may improve the stability of compositions with high amylose content (ca. 70%) up to 10%, 11%, 12%, 13%, 14%, 15%, 16%, 17%, 18%, 19%, 20%, 21%, 22%, 23%, 24%, 25%, 25%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, or 80%, as compared to compositions with low amylose content (ca. 20-25%), after 1 day, 2 days, 3 days, 4 days, 5 days, 6 days, 1 week, 2 weeks, 3 weeks, or 4 weeks at basic pH. Basic pH may be pH greater than 7. Basic pH may be any pH greater than 7. Basic pH may be 8, 9, 10, 11, or 12. The process may improve the stability of compositions with high amylose content (ca. 70%) up to 33%, as compared to compositions with low amylose content (ca. 20-25%) after 2 weeks at basic pH.

Furthermore, in acidic environments, the degree of hydrolysis of carbohydrates typically increases with higher temperatures, resulting in smaller, lower molecular weight polysaccharides. However, the present process provides an efficient and unexpected method of oxidizing starches at elevated temperature (50-65° C.) to yield compositions comprising at least one oxidized starch that maintains a high fraction of the starch with a higher molecular weight (greater than or equal to 2000 Daltons).

The process may include a step of selecting a starch suitable for nitric acid oxidation. The starch may be amylose, high amylose corn starch, amylopectin, dent corn starch, potato starch, maltodextrins or mixtures thereof.

The process may include a step of combining the starch and an aqueous solution of nitric acid to form a starch/nitric acid reaction mixture and oxidize the starch.

The aqueous solution of nitric acid may comprise the nitric acid in an amount, by weight, of about 30% to about 70%, about 40% to about 70%, about 50% to about 70%, or about 60% to about 70%. The aqueous solution of nitric acid may comprise the nitric acid in an amount, by weight, of about 30%, about 40%, about 50%, about 60%, or about 70%.

The molar ratio of nitric acid to glucose unit of the starch may be about 1:1 to about 6:1, about 2:1 to about 6:1, about 3:1 to about 6:1, about 4:1 to about 6:1, about 3:1 to about 4:1, or about 4:1 to about 5:1. The molar ratio of nitric acid to glucose unit of the starch may be about 1:1, about 2:1, about 3:1, about 4:1, about 5:1, or about 6:1. The molar ratio of nitric acid to glucose unit of the starch is calculated at the end of the reaction step if a fed batch is used (the phrase “fed batch” means starting with one of the reactants in a reaction vessel and then adding the other reactants as the reaction progresses to completion) or if a continuous series of reaction vessels are used and one of the reactants is added at different locations through the reactor train (an amount is added to each reactor vessel in the reactor train).

Optionally, inorganic nitrite can be added into the reaction mixture at any time during the oxidation process. Generally, the inorganic nitrite will be added at the beginning during the period of time that the first reaction mixture is being formed. Generally, once the oxidation reaction has begun, it may no longer be necessary to add any additional nitrite. The inorganic nitrite may be sodium nitrite or other nitrite salts.

The reaction temperature of the oxidation reaction is maintained at a temperature greater than 50° C. but no greater than 65° C. The temperature may be maintained between about 51° C. to about 63° C., about 52° C. to about 60° C., about 52° C. to about 57° C., or about 52° C. to about 55° C. The temperature of the oxidation reaction may be maintained at about 51° C., about 52° C., about 53° C., about 54° C., about 55° C., about 56° C., about 57° C., about 58° C., about 59° C., about 60° C., about 61° C., about 62° C., about 63° C., about 64° C., or about 65° C.

The process requires exposing the starch/nitric acid reaction mixture to the positive pressure of oxygen. Therefore, oxygen is added at a point in time and at some location in the one or more reaction vessels. The addition of oxygen and the location of its addition may be during the formation of the initial or first reaction mixture. Alternatively, in another aspect, oxygen can be added in the last reactor or only reactor (if only a single reactor comprises the reaction train). Still further alternatively, oxygen may be added at a selected reactor in the reaction vessel train. Still further alternatively, oxygen can be added to each individual reaction vessel comprising the reaction vessel train. The oxygen may be introduced into the first reaction mixture by any means known in the art, including bubbling gaseous oxygen through the reaction mixture.

The process may include a step of removing a portion of the nitric acid to provide the composition. The process may include a step of removing all of the nitric acid to provide the composition. The composition may be further isolated by removing all oxidized starch with a molecular weight of less than 2000 Daltons. The nitric acid can be recovered or removed from the reaction mixture using any technique known in the art. For example, evaporation, distillation, nanofiltration, diffusion dialysis or alcohol or ether precipitation can be used.

The final reaction mixture from which nitric acid has been removed may be made basic to convert any residual or remaining nitric acid to inorganic nitrate, and converting the organic acids to a mixture of organic acid salts. Neutralization to a pH greater than 7 with inorganic base, without removal of nitric acid, requires base for all of the nitric acid plus the organic acids and the nitric acid is not directly recovered for further use. In contrast, partial recovery of the nitric acid for reuse by vacuum distillation is advantageous because the recovered nitric acid can be used again for oxidation purposes.

B. Process II: Oxidation of Starch with Nitric Acid and a Co-Catalyst

The process for the oxidation of starch with nitric acid and a co-catalyst can provide the composition described above. This process can produce the composition with improved stability at basic pH. In particular, compositions comprising starches oxidized with this process have unexpectedly greater stability at basic pH versus compositions comprising starches oxidized by the process not employing a co-catalyst (i.e. Process I).

In particular, the process may improve the stability of the composition up to 10%, 11%, 12%, 13%, 14%, 15%, 16%, 17%, 18%, 19%, 20%, 21%, 22%, 23%, 24%, 25%, 25%, 27%, 28%, 29%, 30%, 31%, 32%, 334%, 35%, 36%, 37%, 38%, 39%, 40%, 41%, 42%, 43%, 44%, 45%, 46%, 47%, 48%, 49%, 50%, 55%, 60%, 65%, 70%, 75%, or 80%, as compared to compositions prepared without the use of a co-catalyst, after 1 day, 2 days, 3 days, 4 days, 5 days, 6 days, 1 week, 2 weeks, 3 weeks, or 4 weeks at basic pH. Basic pH may be pH greater than 7. Basic pH may be any pH greater than 7. Basic pH may be 8, 9, 10, 11, or 12. The process may improve the stability of the compositions up to 40%, as compared to compositions prepared without the use of a co-catalyst, after 2 weeks at basic pH.

Furthermore, in acidic environments, the degree of hydrolysis of carbohydrates typically increases with higher temperatures, resulting in smaller, lower molecular weight polysaccharides. However, the present process provides an efficient and unexpected method of oxidizing starches at elevated temperature (50-65° C.) to yield compositions comprising at least one oxidized starch that maintains a high fraction of the starch with a higher molecular weight (greater than or equal to 2000 Daltons).

The process may include a step of selecting a starch suitable for nitric acid oxidation. The starch may be amylose, high amylose corn starch, amylopectin, dent corn starch, potato starch, maltodextrins or mixtures thereof.

The process may include a step of combining the starch and an aqueous solution of nitric acid and at least one co-catalyst to form a starch/nitric acid reaction mixture and oxidize the starch.

The aqueous solution of nitric acid may comprise the nitric acid in an amount, by weight, of about 30% to about 70%, about 40% to about 70%, about 50% to about 70%, or about 60% to about 70%. The aqueous solution of nitric acid may comprise the nitric acid in an amount, by weight, of about 30%, about 40%, about 50%, about 60%, or about 70%.

Oxidation of secondary hydroxyl groups of the starch to the corresponding carboxylic acid groups may also result in formation of ketone moieties due to incomplete oxidation. These ketone containing starches may be less stable than the more fully oxidized starches due to the reactive nature of the ketone moieties. However, addition of a co-catalyst to the reaction mixture may result in a more complete oxidation of the secondary hydroxyl groups to the corresponding carboxylic acid groups, which are less reactive moieties, and result in a more stable composition.

The co-catalyst may comprise vanadium, chromium, manganese, iron, cobalt, copper, molybdenum, tungsten or mixtures thereof. The co-catalyst may be ammonium vanadate, ammonium metavanadate, and vanadium oxide. The co-catalyst may be present in an amount of 0.001 to 0.1 molar equivalents, relative to the glucose unit of the starch. The co-catalyst may be present in an amount of 0.001 to 0.05 molar equivalents, 0.001 to 0.01 molar equivalents, 0.001 to 0.009 molar equivalents, 0.001 to 0.008 molar equivalents, 0.001 to 0.007 molar equivalents, 0.001 to 0.006 molar equivalents, or 0.001 to 0.005 molar equivalents, relative to the glucose unit of the starch. The co-catalyst may be present in an amount of 0.1 molar equivalents, 0.05 molar equivalents, 0.01 molar equivalents, 0.009 molar equivalents, 0.008 molar equivalents, 0.007 molar equivalents, 0.006 molar equivalents, 0.005 molar equivalents, 0.004 molar equivalents, 0.003 molar equivalents, 0.002 molar equivalents, or 0.001 molar equivalents, relative to the glucose unit of the starch.

The molar ratio of nitric acid to glucose unit of the starch may be about 1:1 to about 6:1, about 2:1 to about 6:1, about 3:1 to about 6:1, about 4:1 to about 6:1, about 3:1 to about 4:1, or about 4:1 to about 5:1. The molar ratio of nitric acid to glucose unit of the starch may be about 1:1, about 2:1, about 3:1, about 4:1, about 5:1, or about 6:1. The molar ratio of nitric acid to glucose unit of the starch is calculated at the end of the reaction step if a fed batch is used (the phrase “fed batch” means starting with one of the reactants in a reaction vessel and then adding the other reactants as the reaction progresses to completion) or if a continuous series of reaction vessels are used and one of the reactants is added at different locations through the reactor train (an amount is added to each reactor vessel in the reactor train).

Optionally, inorganic nitrite can be added into the reaction mixture at any time during the oxidation process. Generally, the inorganic nitrite will be added at the beginning during the period of time that the first reaction mixture is being formed. Generally, once the oxidation reaction has begun, it may no longer be necessary to add any additional nitrite. The inorganic nitrite may be sodium nitrite or other nitrite salts.

The reaction temperature of the oxidation reaction is maintained at a temperature greater than 50° C. but no greater than 65° C. The temperature may be maintained between about 51° C. to about 63° C., about 52° C. to about 60° C., about 52° C. to about 57° C., or about 52° C. to about 55° C. The temperature of the oxidation reaction may be maintained at about 51° C., about 52° C., about 53° C., about 54° C., about 55° C., about 56° C., about 57° C., about 58° C., about 59° C., about 60° C., about 61° C., about 62° C., about 63° C., about 64° C., or about 65° C.

The process requires exposing the starch/nitric acid reaction mixture to the positive pressure of oxygen. Therefore, oxygen is added at a point in time and at some location in the one or more reaction vessels. The addition of oxygen and the location of its addition may be during the formation of the initial or first reaction mixture. Alternatively, in another aspect, oxygen can be added in the last reactor or only reactor (if only a single reactor comprises the reaction train). Still further alternatively, oxygen may be added at a selected reactor in the reaction vessel train. Still further alternatively, oxygen can be added to each individual reaction vessel comprising the reaction vessel train. The oxygen may be introduced into the first reaction mixture by any means known in the art, including bubbling gaseous oxygen through the reaction mixture.

The process may include a step of removing a portion of the nitric acid to provide the composition. The process may include a step of removing all of the nitric acid to provide the composition. The composition may be further isolated by removing all oxidized starch with a molecular weight of less than 2000 Daltons. The nitric acid can be recovered or removed from the reaction mixture using any technique known in the art. For example, evaporation, distillation, nanofiltration, diffusion dialysis or alcohol or ether precipitation can be used.

The final reaction mixture from which nitric acid has been removed may be made basic to convert any residual or remaining nitric acid to inorganic nitrate, and converting the organic acids to a mixture of organic acid salts. Neutralization to a pH greater than 7 with inorganic base, without removal of nitric acid, requires base for all of the nitric acid plus the organic acids and the nitric acid is not directly recovered for further use. In contrast, partial recovery of the nitric acid for reuse by vacuum distillation is advantageous because the recovered nitric acid can be used again for oxidation purposes.

C. Process III: Oxidation of Starch with Nitric Acid Followed by a Second Oxidation Step

Adding a second oxidation step to Process I can provide the composition described above. This process can produce the composition with improved stability at basic pH. In particular, compositions comprising starches oxidized with this process have unexpectedly greater stability at basic pH versus compositions comprising starches oxidized by the process not employing a second oxidation step (i.e. Process I).

In particular, the process may improve the stability of the composition up to 10%, 11%, 12%, 13%, 14%, 15%, 16%, 17%, 18%, 19%, 20%, 21%, 22%, 23%, 24%, 25%, 25%, 27%, 28%, 29%, 30%, 31%, 32%, 334%, 35%, 36%, 37%, 38%, 39%, 40%, 41%, 42%, 43%, 44%, 45%, 46%, 47%, 48%, 49%, 50%, 55%, 60%, 65%, 70%, 75%, or 80%, as compared to compositions prepared without the use of a second oxidation step, after 1 day, 2 days, 3 days, 4 days, 5 days, 6 days, 1 week, 2 weeks, 3 weeks, or 4 weeks at basic pH. Basic pH may be pH greater than 7. Basic pH may be any pH greater than 7. Basic pH may be 8, 9, 10, 11, or 12. The process may improve the stability of the compositions up to 47%, as compared to compositions prepared without the use of a second oxidation step, after 2 weeks at basic pH.

Furthermore, in acidic environments, the degree of hydrolysis of carbohydrates typically increases with higher temperatures, resulting in smaller, lower molecular weight polysaccharides. However, the present process provides an efficient and unexpected method of oxidizing starches at elevated temperature (50-65° C.) to yield compositions comprising at least one oxidized starch that maintains a high fraction of the starch with a higher molecular weight (greater than or equal to 2000 Daltons).

The process may include a step of selecting a starch suitable for nitric acid oxidation. The starch may be amylose, high amylose corn starch, amylopectin, dent corn starch, potato starch, maltodextrins or mixtures thereof.

The process may include a step of combining the starch and an aqueous solution of nitric acid to form a starch/nitric acid reaction mixture and oxidize the starch.

The aqueous solution of nitric acid may comprise the nitric acid in an amount, by weight, of about 30% to about 70%, about 40% to about 70%, about 50% to about 70%, or about 60% to about 70%. The aqueous solution of nitric acid may comprise the nitric acid in an amount, by weight, of about 30%, about 40%, about 50%, about 60%, or about 70%.

The molar ratio of nitric acid to glucose unit of the starch may be about 1:1 to about 6:1, about 2:1 to about 6:1, about 3:1 to about 6:1, about 4:1 to about 6:1, about 3:1 to about 4:1, or about 4:1 to about 5:1. The molar ratio of nitric acid to glucose unit of the starch may be about 1:1, about 2:1, about 3:1, about 4:1, about 5:1, or about 6:1. The molar ratio of nitric acid to glucose unit of the starch is calculated at the end of the reaction step if a fed batch is used (the phrase “fed batch” means starting with one of the reactants in a reaction vessel and then adding the other reactants as the reaction progresses to completion) or if a continuous series of reaction vessels are used and one of the reactants is added at different locations through the reactor train (an amount is added to each reactor vessel in the reactor train).

Optionally, inorganic nitrite can be added into the reaction mixture at any time during the oxidation process. Generally, the inorganic nitrite will be added at the beginning during the period of time that the first reaction mixture is being formed. Generally, once the oxidation reaction has begun, it may no longer be necessary to add any additional nitrite. The inorganic nitrite may be sodium nitrite or other nitrite salts.

The reaction temperature of the oxidation reaction is maintained at a temperature greater than 50° C. but no greater than 65° C. The temperature may be maintained between about 51° C. to about 63° C., about 52° C. to about 60° C., about 52° C. to about 57° C., or about 52° C. to about 55° C. The temperature of the oxidation reaction may be maintained at about 51° C., about 52° C., about 53° C. about 54° C., about 55° C., about 56° C., about 57° C. about 58° C., about 59° C. about 60° C., about 61° C., about 62° C., about 63° C., about 64° C., or about 65° C.

The process requires exposing the starch/nitric acid reaction mixture to the positive pressure of oxygen. Therefore, oxygen is added at a point in time and at some location in the one or more reaction vessels. The addition of oxygen and the location of its addition may be during the formation of the initial or first reaction mixture. Alternatively, in another aspect, oxygen can be added in the last reactor or only reactor (if only a single reactor comprises the reaction train). Still further alternatively, oxygen may be added at a selected reactor in the reaction vessel train. Still further alternatively, oxygen can be added to each individual reaction vessel comprising the reaction vessel train. The oxygen may be introduced into the first reaction mixture by any means known in the art, including bubbling gaseous oxygen through the reaction mixture.

The process may include a step of removing a portion of the nitric acid to provide a composition comprising at least one oxidized starch, wherein at least 70% of the oxidized starch has a molecular weight greater than or equal to about 2000 Daltons and a degree of carboxylation of at least 1 mole acid/mole glucose. The process may include a step of removing all of the nitric acid to provide the composition. The composition may be further isolated by removing all oxidized starch with a molecular weight of less than 2000 Daltons. The nitric acid can be recovered or removed from the reaction mixture using any technique known in the art. For example, evaporation, distillation, nanofiltration, diffusion dialysis or alcohol or ether precipitation can be used.

The reaction mixture from which nitric acid has been removed may be made basic to convert any residual or remaining nitric acid to inorganic nitrate, and converting the organic acids to a mixture of organic acid salts. Neutralization to a pH greater than 7 with inorganic base, without removal of nitric acid, requires base for all of the nitric acid plus the organic acids and the nitric acid is not directly recovered for further use. In contrast, partial recovery of the nitric acid for reuse by vacuum distillation is advantageous because the recovered nitric acid can be used again for oxidation purposes.

The process may further include a step of combining, over time, employing a controlled process, the composition comprising at least one oxidized starch and at least one oxidant to oxidize the starch a second time to form a further composition comprising at least one oxidized starch, wherein at least 70% of the oxidized starch has a molecular weight greater than or equal to 2000 Daltons and a degree of carboxylation of at least 0.5 mole acid/mole glucose and further wherein the composition is stable at a pH greater than 7.

Oxidation of secondary hydroxyl groups of the starch to the corresponding carboxylic acid groups may also result in formation of ketone moieties due to incomplete oxidation. These ketone containing starches may be less stable than the more fully oxidized starches due to the reactive nature of the ketone moieties. However, addition of a second oxidation step to the process may result in a more complete oxidation of the secondary hydroxyl groups to the corresponding carboxylic acid groups, which are less reactive moieties, and result in a more stable composition.

The at least one oxidant may be added as an aqueous solution. The at least one oxidant may be a peroxide. The peroxide may be hydrogen peroxide. The at least one oxidant may be sodium periodate or sodium hypochlorite. The at least one oxidant may be a peroxy acid. The peroxy acid may be peracetic acid or meta-chloroperoxybenzoic acid. The at least one oxidant may be hydrogen peroxide, sodium periodate, sodium hypochlorite, peracetic acid, meta-chloroperoxybenzoic acid, or mixtures thereof. The molar ratio of peroxide to glucose unit of the starch may be about 1:1 to about 6:1, about 2:1 to about 6:1, about 3:1 to about 6:1, about 4:1 to about 6:1, about 3:1 to about 4:1, or about 4:1 to about 5:1. The molar ratio of peroxide to glucose unit of the starch may be about 1:1, about 2:1, about 3:1, about 4:1, about 5:1, or about 6:1. The molar ratio of peroxide to glucose unit of the starch is calculated at the end of the reaction step if a fed batch is used (the phrase “fed batch” means starting with one of the reactants in a reaction vessel and then adding the other reactants as the reaction progresses to completion) or if a continuous series of reaction vessels are used and one of the reactants is added at different locations through the reactor train (an amount is added to each reactor vessel in the reactor train).

D. Other Reaction Conditions of Processes I-III

The processes described above may be achieved in an open vessel or may be achieved in one or more closed reaction vessels comprising one or more reactors. The one or more closed reaction vessels may be in series (continuous) or in parallel with one another (batch). Any type of reaction vessel that allows for the gas and liquid phases to have a high mass transfer during the oxidation reaction can be used. Examples of reactor vessels that can be used include one or more continuously stirred tank reactors (CSTRs), plug flow reactors, spinning disc reactors, or tubular type plug flow reactors. Additionally, the reaction vessel can contain heat transfer systems such as coils, jackets, loops, etc. Suitable for these processes are almost any type of reactor that mixes, controls temperature and pressure, and has a liquid and gas phase (not hydraulically full). Furthermore, when one or more reaction vessels are used, any combination of different types and kinds of reaction vessels can be used. For example, the reaction train can contain a combination of one or more CSTRs, one or more tubular type plug flow reactors, and/or one or more evaporators. The reaction train can contain one reaction vessel, two reaction vessels, three reaction vessels, four reaction vessels, five reaction vessels, six reaction vessels, seven reaction vessels, eight reaction vessels, nine reaction vessels or ten reaction vessels. If one or more reaction vessels are used, the reaction vessels can be connected in series with one another or one (such as in a continuous process) or one or more reaction vessels can be used in parallel (such as in a batch process).

The reaction vessel can be described as a container or vessel that is insulated from the external environment, such that the reaction mixture contained within the tank reactor is not exposed to ambient air. Additionally, the reaction vessel can comprise one or more mixing elements that are capable of continuously stirring and providing controlled agitation of the reaction mixture within the vessel. The one or more mixing elements may include, but are not limited to magnetic stirrers, propeller stirrers, turbine stirrers, anchor stirrers, kneading stirrers, centrifugal stirrers, paddle stirrers and combinations thereof. Generally, the mixing element is electronically controlled such that the spinning velocity of the mixing element may be altered as needed.

The reaction vessel typically maintains a vapor or head space wherein the gaseous phase (gaseous oxides of nitrogen) exists in addition to the liquid phase. The vapor or head space is created by filling the tank reactor with a volume of the reaction mixture that is less than 100% of the volume of the tank. Generally, the reaction vessel is filled with a volume that ranges from approximately 1% of the reaction vessel volume to approximately 99% of the reaction vessel volume. The vapor or head space of the reaction vessel may also be maintained at a desirable temperature according to the specified reaction conditions. The vapor or head space may be maintained at a temperature less than the temperature of the liquid phase in the reaction vessel.

By specifically controlling the head space temperature and pressure, an improvement in the rate of conversion of nitrogen oxides to nitric acid in the vapor space can be realized. Specifically, cooling the headspace below the temperature of the liquid phase can improve (increase) the overall rate of nitric acid regeneration, as evidenced by a reduction in the number of units of nitrogen oxides (such as NO₂) generated in the headspace. Increasing the rate of nitric acid regeneration allows the oxidation processes of this disclosure to use less nitric acid than previously described to achieve the same degree of oxidation. In addition, the processes of the present disclosure are more economical because less nitric acid is lost during pressure control venting of the reaction and during the recovery steps of the processes. Additionally, controlling the headspace temperature as described herein results in the reaction vessel having to be vented less frequently or not at all during the oxidation process, specifically when compared with processes that do not control the headspace temperature.

For further description of processes for the oxidation of carbohydrates and sugars with nitric acid, see U.S. patent application Ser. No. 14/206,796, the contents of which are fully incorporated herein.

### 4. USE OF THE COMPOSITION

The compositions may be useful as dispersing agents in detergents and cleaning compositions, in paper and textile sizing agents, and as thickening agents in foods. The composition may be particularly well-suited to these applications due to its advantageous properties, such as its stability at basic pH.

The present disclosure has multiple aspects, illustrated by the following non-limiting examples.

### 5. EXAMPLES

### Example 1

### Oxidation of Starch

A round bottom flask charged with a stir bar and nitric acid (20.5 g of a 70% aq. solution) was heated to 45° C. with stirring (temperature was monitored by a thermocouple probe placed in the middle of the solution). After maintaining the temperature at 45° C., solid sodium nitrite (0.1 g) was added to the solution resulting in the solution becoming a pale gold color. Solid potato starch (10 g) was added to the pale gold nitric acid solution and mixing was aided by hand with a spatula due to the viscous nature of the resulting batter-like solution. A heat of dissolution (4-6° C.) was observed after starch addition and lasted for 5 minutes upon which time the reaction temperature returned to 45° C. After stirring the reaction mixture 20 minutes, a reaction exotherm raised the reaction temperature to 52° C. During this time brown NO₂ gas was produced and a foam layer formed on top of the reaction mixture. The reaction mixture then became a green color and decreased in viscosity. The reaction temperature was maintained at 52° C. with an intermittent cold water bath during the entirety of the exotherm. After the exotherm was complete (about 90 minutes), the reaction was heated to maintain a temperature of 52° C. until the reaction was halted by placing the round bottom flask in an ice bath for total reaction time of 260 minutes. The final reaction mixture was a vibrant blue/green color and had the viscosity of a thin syrup.

The entire oxidized starch reaction mixture was dialyzed 3 times against a 20 fold excess of water using 2000 Dalton molecular weight cut-off dialysis membrane. This separated the nitric acid and small carbohydrates from the oxidized starch polymers greater than 2000 Daltons. The oxidized starch greater than 2000 Daltons was dried by vacuum evaporation at 35° C. to provide 7 g (70% yield) of a glassy white amorphous solid.

### Example 2

### Degree of Acid Substitution Titration

A 3-4% (1.74 g in 25 mL DI water) oxidized starch solution containing phenolphthalein indicator was titrated with a standardized sodium hydroxide solution. The number of moles of carboxylic acid groups per gram oxidized starch was determined by the total moles of sodium hydroxide required for neutralization (4.28 mmoles). To estimate the degree of carboxylation per glucose repeating unit in the oxidized starch polymer, the moles of acid per gram value was multiplied by 180 grams to give a polymer starch product with 1 mole carboxyl/glucose repeating unit.

### Example 3

### Improved Stability of Oxidation Products with Differing Feedstocks

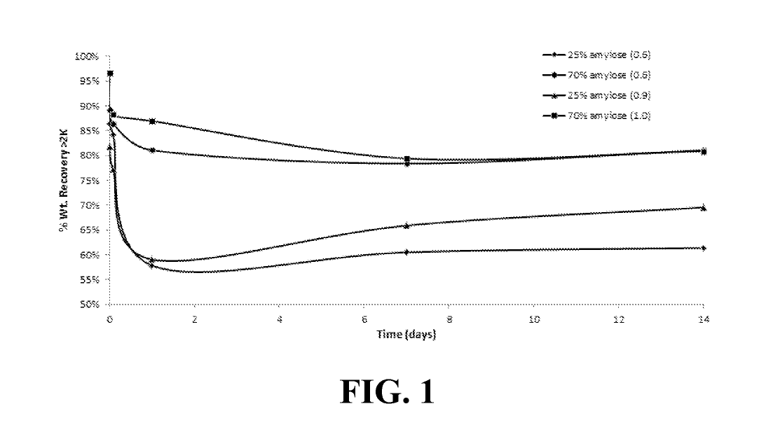

The procedure of Example 1 was employed for the oxidation of a series of starches (Table 1). The oxidized starches were evaluated for stability at 22° C. and pH 10 over the course of 2 weeks (14 days). In these studies, stability refers to the weight percentage of oxidized starch greater than 2000 Daltons in the composition. These results demonstrate that oxidized starch having high amylose content (70%) has greater stability (entries 1 and 2, Table 1) than oxidized starch having low amylose content (25%) (entries 3 and 4, Table 1) prepared by these methods (Table 1 and FIG. 1). In particular, the high amylose compositions demonstrated a 16-33% improvement in stability over the low amylose compositions at two weeks.

TABLE 1

| | Degree of | initial | 1 day | 7 day | 14 day |
|---|---|---|---|---|---|
| Starch | oxidation | stability | stability | stability | stability |
| 70% amylose | 1.0 | 97% | 87% | 79% | 81% |
| corn starch | | | | | |
| 70% amylose | 0.6 | 89% | 81% | 78% | 81% |
| corn starch | | | | | |
| 25% amylose | 0.9 | 81% | 59% | 66% | 70% |
| potato starch | | | | | |
| 25% amylose | 0.5 | 86% | 58% | 61% | 61% |
| potato starch | | | | | |

### Example 4

### Improved Stability of Oxidation Product with a Vanadium Co-Catalyst

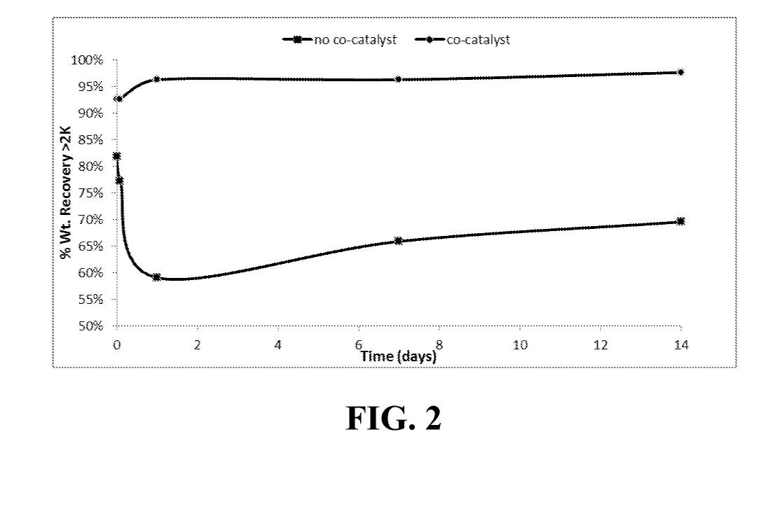

The procedure of Example 1 was employed for the oxidation of a series of low amylose containing starches (Table 2). The procedure was modified for the oxidation of one of the starches (1^{st} entry of Table 2) by addition of 0.5 mol % of ammonium metavanadate. The oxidized starches were evaluated for stability at 22° C. and pH 10 over the course of 2 weeks (14 days). In these studies, stability refers to weight percentage of oxidized starch greater than 2000 Daltons in the composition. These results demonstrate that compositions provided by the process for the oxidation of starch with nitric acid and a co-catalyst (entry 1, Table 2) have greater stability than compositions provided by a process not employing a co-catalyst (entry 2, Table 2) (Table 2 and FIG. 2). In particular, the composition made with the co-catalyst process demonstrated a 40% improvement in stability at two weeks, over the composition made by the non-co-catalyst process.

TABLE 2

| | | | | | 7 day | |
|---|---|---|---|---|---|---|
| | | Degree of | initial | 1 day | sta- | 14 day |
| Starch | Co-catalyst | oxidation | stability | stability | bility | stability |
| 20-25% | Ammonium | 1.1 | 93% | 96% | 96% | 98% |
| amylose | metavanadate | | | | | |
| potato | | | | | | |
| starch | | | | | | |
| 20-25% | none | 0.9 | 82% | 59% | 66% | 70% |
| amylose | | | | | | |
| potato | | | | | | |
| starch | | | | | | |

### Example 5

### Improved Stability of Oxidation Product after Secondary Peroxide Oxidation

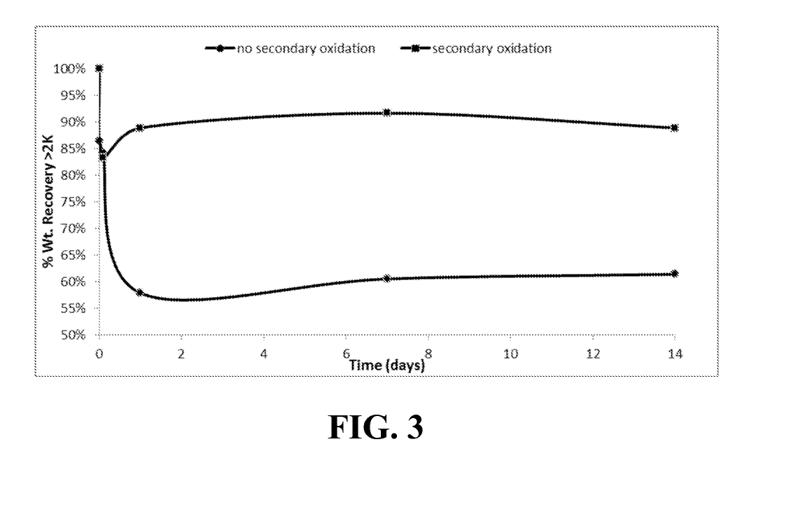

The procedure of Example 1 was employed for the oxidation of a series of low amylose containing starches (Table 3). The procedure was modified for the oxidation of one of the starches (1^{st} entry of Table 3) by adding a second oxidation step employing 1-4 molar equivalents of hydrogen peroxide. The oxidized starches were evaluated for stability at 22° C. and pH 10 over the course of 2 weeks (14 days). In these studies, stability refers to the weight percentage of the oxidized starch greater than 2000 Daltons in the composition. These results demonstrate that compositions provided by a process including a second oxidation step (Process III, entry 1 of Table 3) have greater stability than compositions provided by a process not employing the second oxidation step (Process I, entry 2 of Table 3) (Table 3 and FIG. 3). In particular, the composition made with the two oxidation process demonstrated a 47% improvement in stability at two weeks, over the composition made without the two oxidation process.

TABLE 3

| | | Degree of | initial | 1 day | 7 day | 14 day |
|---|---|---|---|---|---|---|
| Starch | peroxide | oxidation | stability | stability | stability | stability |
| 20-25% | hydrogen | 0.9 | 86% | 89% | 92% | 89% |
| amylose | peroxide | | | | | |
| dent corn | | | | | | |
| starch | | | | | | |
| 20-25% | none | 0.9 | 86% | 58% | 61% | 61% |
| amylose | | | | | | |
| dent corn | | | | | | |
| starch | | | | | | |

It is understood that the foregoing detailed description and accompanying examples are merely illustrative and are not to be taken as limitations upon the scope of the invention, which is defined solely by the appended claims and their equivalents.

Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

For reasons of completeness, various aspects of the present disclosure are set out in the following numbered clauses:

Clause 1. A composition comprising at least one oxidized starch, wherein at least 70% of the oxidized starch has a molecular weight greater than or equal to 2000 Daltons and a degree of carboxylation of at least 0.5 mole acid/mole glucose.

Clause 2. The composition of clause 1, wherein the oxidized starch comprises oxidized amylose, oxidized high amylose corn starch, oxidized amylopectin, oxidized dent corn starch, oxidized potato starch, maltodextrins, oxidized pea starch, or mixtures thereof.

Clause 3. The composition of clause 1, wherein the oxidized starch comprises oxidized high amylose starch, oxidized potato starch, or oxidized dent corn starch.

Clause 4. The composition of clause 3. wherein the oxidized starch is stable at pH greater than 7.

Clause 5. The composition of clause 3, wherein the oxidized starch is stable at pH greater than 7 for at least 2 weeks.

Clause 6. The composition of clause 1, wherein at least 75% of the oxidized starch has a molecular weight greater than or equal to 2000 Daltons and a degree of carboxylation of at least 0.5 mole acid/mole glucose.

Clause 7. The composition of clause 1, wherein at least 80% of the oxidized starch has a molecular weight greater than or equal to 2000 Daltons and a degree of carboxylation of at least 0.5 mole acid/mole glucose.

Clause 8. The composition of clause 1, wherein at least 85% of the oxidized starch has a molecular weight greater than or equal to 2000 Daltons and a degree of carboxylation of at least 0.5 mole acid/mole glucose.

Clause 9. The composition of clause 1, wherein at least 90% of the oxidized starch has a molecular weight greater than or equal to 2000 Daltons and a degree of carboxylation of at least 0.5 mole acid/mole glucose.

Clause 10. The composition of clause 1, wherein at least 95% of the oxidized starch has a molecular weight greater than or equal to 2000 Daltons and a degree of carboxylation of at least 0.5 mole acid/mole glucose.

Clause 11. The composition of clause 1, wherein at least 70% of the oxidized starch has a molecular weight greater than or equal to 2000 Daltons and a degree of carboxylation of at least 1 mole acid/mole glucose.

Clause 12. The composition of clause 1, wherein at least 75% of the oxidized starch has a molecular weight greater than or equal to 2000 Daltons and a degree of carboxylation of at least 1 mole acid/mole glucose.

Clause 13. The composition of clause 1, wherein at least 80% of the oxidized starch has a molecular weight greater than or equal to 2000 Daltons and a degree of carboxylation of at least 1 mole acid/mole glucose.

Clause 14. The composition of clause 1, wherein at least 85% of the oxidized starch has a molecular weight greater than or equal to 2000 Daltons and a degree of carboxylation of at least 1 mole acid/mole glucose.

Clause 15. The composition of clause 1, wherein at least 90% of the oxidized starch has a molecular weight greater than or equal to 2000 Daltons and a degree of carboxylation of at least 1 mole acid/mole glucose.

Clause 16. The composition of clause 1, wherein at least 95% of the oxidized starch has a molecular weight greater than or equal to 2000 Daltons and a degree of carboxylation of at least 1 mole acid/mole glucose.

Clause 17. A process of preparing a composition comprising at least one oxidized starch, wherein at least 70% of the oxidized starch has a molecular weight greater than or equal to 2000 Daltons and a degree of carboxylation of at least 0.5 mole acid/mole glucose, the process comprising the steps of:

a. selecting a starch suitable for nitric acid oxidation, wherein the starch is selected from the group consisting of amylose, high amylose corn starch, amylopectin, dent corn starch, potato starch, maltodextrins and mixtures thereof;

b. combining the starch and an aqueous solution of nitric acid to form a starch/nitric acid reaction mixture; wherein the molar ratio of nitric acid to glucose unit of the starch is about 2:1;

c. maintaining a temperature greater than 50° C. but no greater than 65° C., controlling a positive pressure of oxygen, and controlling agitation of the starch/nitric acid reaction mixture; and

d. removing a portion of the nitric acid from the reaction mixture to give a composition comprising at least one oxidized starch, wherein at least 70% of the oxidized starch has a molecular weight greater than or equal to 2000 Daltons and a degree of carboxylation of at least 0.5 mole acid/mole glucose.

Clause 18. The process of clause 17, wherein the temperature is maintained between about 51° C. to about 63° C.

Clause 19. The process of clause 18, wherein the temperature is maintained between about 52° C. to about 60° C.

Clause 20. The process of clause 19, wherein the temperature is maintained between about 52° C. to about 57° C.

Clause 21. The process of clause 20, wherein the temperature is maintained between about 52° C. to about 55° C.

Clause 22. The process of clause 17, wherein the aqueous solution of nitric acid comprises, by weight, about 30% to about 70% nitric acid.

Clause 23. The process of clause 17, wherein the aqueous solution of nitric acid comprises, by weight, about 70% nitric acid.

Clause 24. The process of clause 17, wherein the starch is high amylose corn starch.

Clause 25. The process of clause 24, wherein the oxidized starch is oxidized high amylose corn starch.

Clause 26. The process of clause 25, wherein the oxidized starch is stable at pH greater than 7.

Clause 27. The process of clause 25, wherein the oxidized starch is stable at pH greater than 7 for at least 2 weeks.

Clause 28. The process of clause 17, wherein at least 75% of the oxidized starch has a molecular weight greater than or equal to 2000 Daltons and a degree of carboxylation of at least 0.5 mole acid/mole glucose

Clause 29. The process of clause 17, wherein at least 80% of the oxidized starch has a molecular weight greater than or equal to 2000 Daltons and a degree of carboxylation of at least 0.5 mole acid/mole glucose

Clause 30. The process of clause 17, wherein at least 85% of the oxidized starch has a molecular weight greater than or equal to 2000 Daltons and a degree of carboxylation of at least 0.5 mole acid/mole glucose.

Clause 31. The process of clause 17, wherein at least 90% of the oxidized starch has a molecular weight greater than or equal to 2000 Daltons and a degree of carboxylation of at least 0.5 mole acid/mole glucose

Clause 32. The process of clause 17, wherein at least 95% of the oxidized starch has a molecular weight greater than or equal to 2000 Daltons and a degree of carboxylation of at least 0.5 mole acid/mole glucose.

Clause 33. The process of clause 17, wherein at least 70% of the oxidized starch has a molecular weight greater than or equal to 2000 Daltons and a degree of carboxylation of at least 1 mole acid/mole glucose.

Clause 34. The process of clause 17, wherein at least 75% of the oxidized starch has a molecular weight greater than or equal to 2000 Daltons and a degree of carboxylation of at least 1 mole acid/mole glucose.

Clause 35. The process of clause 17, wherein at least 80% of the oxidized starch has a molecular weight greater than or equal to 2000 Daltons and a degree of carboxylation of at least 1 mole acid/mole glucose.

Clause 36. The process of clause 17, wherein at least 85% of the oxidized starch has a molecular weight greater than or equal to 2000 Daltons and a degree of carboxylation of at least 1 mole acid/mole glucose.

Clause 37. The process of clause 17, wherein at least 90% of the oxidized starch has a molecular weight greater than or equal to 2000 Daltons and a degree of carboxylation of at least 1 mole acid/mole glucose.

Clause 38. The process of clause 17, wherein at least 95% of the oxidized starch has a molecular weight greater than or equal to 2000 Daltons and a degree of carboxylation of at least 1 mole acid/mole glucose.

Clause 39. A process of preparing a composition comprising at least one oxidized starch, wherein at least 70% of the oxidized starch has a molecular weight greater than or equal to 2000 Daltons and a degree of carboxylation of at least 0.5 mole acid/mole glucose, the process comprising the steps of:

a. selecting a starch suitable for nitric acid oxidation, wherein the starch is selected from the group consisting of amylose, high amylose corn starch, amylopectin, dent corn starch, potato starch, maltodextrins, and mixtures thereof;

b. combining the starch, an aqueous solution of nitric acid and at least one co-catalyst to form a starch/nitric acid reaction mixture; wherein the molar ratio of nitric acid to glucose unit of the starch is about 2:1;

c. maintaining a temperature greater than 50° C. but no greater than 65° C., controlling a positive pressure of oxygen, and controlling agitation of the starch/nitric acid reaction mixture; and

d. removing a portion of the nitric acid from the reaction mixture to give a composition comprising at least one oxidized starch, wherein at least 70% of the oxidized starch has a molecular weight greater than or equal to 2000 Daltons and a degree of carboxylation of at least 0.5 mole acid/mole glucose.

Clause 40. The process of clause 39, wherein the temperature is maintained between about 51° C. to about 63° C.

Clause 41. The process of clause 40, wherein the temperature is maintained between about 52° C. to about 60° C.

Clause 42. The process of clause 41, wherein the temperature is maintained between about 52° C. to about 57° C.

Clause 43. The process of clause 42, wherein the temperature is maintained between about 52° C. to about 55° C.

Clause 44. The process of clause 39, wherein the aqueous solution of nitric acid comprises, by weight, about 30% to about 70% nitric acid.

Clause 45. The process of clause 39, wherein the aqueous solution of nitric acid comprises, by weight, about 70% nitric acid.

Clause 46. The process of clause 39, wherein the starch is potato starch.

Clause 47. The process of clause 46, wherein the oxidized starch is oxidized potato starch.

Clause 48. The process of clause 47, wherein the oxidized starch is stable at pH greater than 7.

Clause 49. The process of clause 47, wherein the oxidized starch is stable at pH greater than 7 for at least 2 weeks.

Clause 50. The process of clause 39, wherein at least 75% of the oxidized starch has a molecular weight greater than or equal to 2000 Daltons and a degree of carboxylation of at least 0.5 mole acid/mole glucose.

Clause 51. The process of clause 39, wherein at least 80% of the oxidized starch has a molecular weight greater than or equal to 2000 Daltons and a degree of carboxylation of at least 0.5 mole acid/mole glucose.

Clause 52. The process of clause 39, wherein at least 85% of the oxidized starch has a molecular weight greater than or equal to 2000 Daltons and a degree of carboxylation of at least 0.5 mole acid/mole glucose.

Clause 53. The process of clause 39, wherein at least 90% of the oxidized starch has a molecular weight greater than or equal to 2000 Daltons and a degree of carboxylation of at least 0.5 mole acid/mole glucose.

Clause 54. The process of clause 39, wherein at least 95% of the oxidized starch has a molecular weight greater than or equal to 2000 Daltons and a degree of carboxylation of at least 0.5 mole acid/mole glucose.

Clause 55. The process of clause 39, wherein at least 70% of the oxidized starch has a molecular weight greater than or equal to 2000 Daltons and a degree of carboxylation of at least 1 mole acid/mole glucose.

Clause 56. The process of clause 39, wherein at least 75% of the oxidized starch has a molecular weight greater than or equal to 2000 Daltons and a degree of carboxylation of at least 1 mole acid/mole glucose.

Clause 57. The process of clause 39, wherein at least 80% of the oxidized starch has a molecular weight greater than or equal to 2000 Daltons and a degree of carboxylation of at least 1 mole acid/mole glucose.

Clause 58. The process of clause 39, wherein at least 85% of the oxidized starch has a molecular weight greater than or equal to 2000 Daltons and a degree of carboxylation of at least 1 mole acid/mole glucose.

Clause 59. The process of clause 39, wherein at least 90% of the oxidized starch has a molecular weight greater than or equal to 2000 Daltons and a degree of carboxylation of at least 1 mole acid/mole glucose.

Clause 60. The process of clause 39, wherein at least 95% of the oxidized starch has a molecular weight greater than or equal to 2000 Daltons and a degree of carboxylation of at least 1 mole acid/mole glucose.

Clause 61. The process of clause 39, wherein the co-catalyst comprises vanadium, chromium, manganese, iron, cobalt, copper, molybdenum, tungsten or mixtures thereof.

Clause 62. The process of clause 39, wherein the co-catalyst is ammonium metavanadate, ammonium vanadate, or vanadium oxide.

Clause 63. The process of clause 39, wherein the amount of co-catalyst is 0.001 to 0.1 molar equivalents, relative to the glucose unit of the starch.

Clause 64. A process of preparing a composition comprising at least one oxidized starch, wherein at least 70% of the oxidized starch has a molecular weight greater than or equal to 2000 Daltons and a degree of carboxylation of at least 0.5 mole acid/mole glucose and further wherein the composition is stable at a pH greater than 7, the process comprising the steps of:

a. selecting a starch suitable for nitric acid oxidation, wherein the starch is selected from the group consisting of amylose, high amylose corn starch, amylopectin, dent corn starch, potato starch, maltodextrins, and mixtures thereof;

b. combining the starch and an aqueous solution of nitric acid to form a starch/nitric acid reaction mixture; wherein the molar ratio of nitric acid to glucose unit of the starch is about 2:1;

c. maintaining a temperature greater than 50° C. but no greater than 65° C., controlling a positive pressure of oxygen, and controlling agitation of the starch/nitric acid reaction mixture;

d. removing a portion of the nitric acid from the reaction mixture to give a composition comprising at least one oxidized starch, wherein at least 70% of the oxidized starch has a molecular weight greater than or equal to about 2000 Daltons and a degree of carboxylation of at least 0.5 mole acid/mole glucose; and

e. combining the composition of step d and at least one oxidant to form a further composition comprising at least one oxidized starch; wherein the molar ratio of the oxidant to glucose unit of the starch is about 1:1 to about 5:1; wherein at least 70% of the oxidized starch has a molecular weight greater than or equal to 2000 Daltons and a degree of carboxylation of at least 0.5 mole acid/mole glucose and further wherein the composition is stable at a pH greater than 7.

Clause 65. The process of clause 64, wherein the temperature is maintained between about 51° C. to about 63° C.

Clause 66. The process of clause 65, wherein the temperature is maintained between about 52° C. to about 60° C.

Clause 67. The process of clause 66, wherein the temperature is maintained between about 52° C. to about 57° C.

Clause 68. The process of clause 67, wherein the temperature is maintained between about 52° C. to about 55° C.

Clause 69. The process of clause 64, wherein the aqueous solution of nitric acid comprises, by weight, about 30% to about 70% nitric acid.

Clause 70. The process of clause 64, wherein the aqueous solution of nitric acid comprises, by weight, about 70% nitric acid.

Clause 71. The process of clause 64, wherein the starch is dent corn starch.

Clause 72. The process of clause 71, wherein the oxidized starch is oxidized dent corn starch.

Clause 73. The process of clause 72, wherein the oxidized starch after the second oxidation is stable at pH greater than 7.

Clause 74. The process of clause 72, wherein the oxidized starch after the second oxidation is stable at pH greater than 7 for at least 2 weeks.

Clause 75. The process of clause 64, wherein at least 75% of the oxidized starch has a molecular weight greater than or equal to 2000 Daltons and a degree of carboxylation of at least 0.5 mole acid/mole glucose.

Clause 76. The process of clause 64, wherein at least 80% of the oxidized starch has a molecular weight greater than or equal to 2000 Daltons and a degree of carboxylation of at least 0.5 mole acid/mole glucose.

Clause 77. The process of clause 64, wherein at least 85% of the oxidized starch has a molecular weight greater than or equal to 2000 Daltons and a degree of carboxylation of at least 0.5 mole acid/mole glucose.

Clause 78. The process of clause 64, wherein at least 90% of the oxidized starch has a molecular weight greater than or equal to 2000 Daltons and a degree of carboxylation of at least 0.5 mole acid/mole glucose.

Clause 80. The process of clause 64, wherein at least 95% of the oxidized starch has a molecular weight greater than or equal to 2000 Daltons and a degree of carboxylation of at least 0.5 mole acid/mole glucose.

Clause 81. The process of clause 64, wherein at least 70% of the oxidized starch has a molecular weight greater than or equal to 2000 Daltons and a degree of carboxylation of at least 1 mole acid/mole glucose.

Clause 82. The process of clause 64, wherein at least 75% of the oxidized starch has a molecular weight greater than or equal to 2000 Daltons and a degree of carboxylation of at least 1 mole acid/mole glucose.

Clause 83. The process of clause 64, wherein at least 80% of the oxidized starch has a molecular weight greater than or equal to 2000 Daltons and a degree of carboxylation of at least 1 mole acid/mole glucose.

Clause 84. The process of clause 64, wherein at least 85% of the oxidized starch has a molecular weight greater than or equal to 2000 Daltons and a degree of carboxylation of at least 1 mole acid/mole glucose.

Clause 84. The process of clause 64, wherein at least 90% of the oxidized starch has a molecular weight greater than or equal to 2000 Daltons and a degree of carboxylation of at least 1 mole acid/mole glucose.

Clause 85. The process of clause 64, wherein at least 95% of the oxidized starch has a molecular weight greater than or equal to 2000 Daltons and a degree of carboxylation of at least 1 mole acid/mole glucose.

Clause 86. The process of clause 64, wherein the at least one oxidant is a peroxide.

Clause 87. The process of clause 64, wherein the at least one oxidant is sodium periodate or sodium hypochlorite.

Clause 88. The process of clause 86, wherein the peroxide is hydrogen peroxide.

Clause 89. The process of clause 64, wherein the at least one oxidant is a peroxy acid.

Clause 90. The process of clause 89, wherein the peroxy acid is peracetic acid or meta-chloroperoxybenzoic acid.

1-63. (canceled)

64. A process of preparing a composition comprising at least one oxidized starch, wherein at least 70% of the oxidized starch has a molecular weight greater than or equal to 2000 Daltons and a degree of carboxylation of at least 0.5 mole acid/mole glucose and further wherein the composition is stable at a pH greater than 7, the process comprising the steps of:
a. selecting a starch suitable for nitric acid oxidation, wherein the starch is selected from the group consisting of amylose, high amylose corn starch, amylopectin, dent corn starch, potato starch, maltodextrins, and mixtures thereof;
b. combining the starch and an aqueous solution of nitric acid to form a starch/nitric acid reaction mixture; wherein the molar ratio of nitric acid to glucose unit of the starch is about 2:1;
c. maintaining a temperature greater than 50° C. but no greater than 65° C., controlling a positive pressure of oxygen, and controlling agitation of the starch/nitric acid reaction mixture;
d. removing a portion of the nitric acid from the reaction mixture to give a composition comprising at least one oxidized starch, wherein at least 70% of the oxidized starch has a molecular weight greater than or equal to about 2000 Daltons and a degree of carboxylation of at least 0.5 mole acid/mole glucose; and
e. combining the composition of step d and at least one oxidant to form a further composition comprising at least one oxidized starch; wherein the molar ratio of the oxidant to glucose unit of the starch is about 1:1 to about 5:1; wherein at least 70% of the oxidized starch has a molecular weight greater than or equal to 2000 Daltons and a degree of carboxylation of at least 0.5 mole acid/mole glucose and further wherein the composition is stable at a pH greater than 7.

65. The process of claim 64, wherein the temperature is maintained between about 51° C. to about 63° C.

66. The process of claim 65, wherein the temperature is maintained between about 52° C. to about 60° C.

67. The process of claim 66, wherein the temperature is maintained between about 52° C. to about 57° C.

68. The process of claim 67, wherein the temperature is maintained between about 52° C. to about 55° C.

69. The process of claim 64, wherein the aqueous solution of nitric acid comprises, by weight, about 30% to about 70% nitric acid.

70. The process of claim 64, wherein the aqueous solution of nitric acid comprises, by weight, about 70% nitric acid.

71. The process of claim 64, wherein the starch is dent corn starch.

72. The process of claim 71, wherein the oxidized starch is oxidized dent corn starch.

73. The process of claim 72, wherein the oxidized starch after the second oxidation is stable at pH greater than 7.

74. The process of claim 72, wherein the oxidized starch after the second oxidation is stable at pH greater than 7 for at least 2 weeks.

75. The process of claim 64, wherein at least 75% of the oxidized starch has a molecular weight greater than or equal to 2000 Daltons and a degree of carboxylation of at least 0.5 mole acid/mole glucose.

76. The process of claim 64, wherein at least 80% of the oxidized starch has a molecular weight greater than or equal to 2000 Daltons and a degree of carboxylation of at least 0.5 mole acid/mole glucose.

77. The process of claim 64, wherein at least 85% of the oxidized starch has a molecular weight greater than or equal to 2000 Daltons and a degree of carboxylation of at least 0.5 mole acid/mole glucose.

78. The process of claim 64, wherein at least 90% of the oxidized starch has a molecular weight greater than or equal to 2000 Daltons and a degree of carboxylation of at least 0.5 mole acid/mole glucose.

79. The process of claim 64, wherein at least 95% of the oxidized starch has a molecular weight greater than or equal to 2000 Daltons and a degree of carboxylation of at least 0.5 mole acid/mole glucose.

80. The process of claim 64, wherein at least 70% of the oxidized starch has a molecular weight greater than or equal to 2000 Daltons and a degree of carboxylation of at least 1 mole acid/mole glucose.

81. The process of claim 64, wherein at least 75% of the oxidized starch has a molecular weight greater than or equal to 2000 Daltons and a degree of carboxylation of at least 1 mole acid/mole glucose.

82. The process of claim 64, wherein at least 80% of the oxidized starch has a molecular weight greater than or equal to 2000 Daltons and a degree of carboxylation of at least 1 mole acid/mole glucose.

83. The process of claim 64, wherein at least 85% of the oxidized starch has a molecular weight greater than or equal to 2000 Daltons and a degree of carboxylation of at least 1 mole acid/mole glucose.

84. The process of claim 64, wherein at least 90% of the oxidized starch has a molecular weight greater than or equal to 2000 Daltons and a degree of carboxylation of at least 1 mole acid/mole glucose.

85. The process of claim 64, wherein at least 95% of the oxidized starch has a molecular weight greater than or equal to 2000 Daltons and a degree of carboxylation of at least 1 mole acid/mole glucose.

86. The process of claim 64, wherein the at least one oxidant is a peroxide.

87. The process of claim 64, wherein the at least one oxidant is sodium periodate or sodium hypochlorite.

88. The process of claim 86, wherein the peroxide is hydrogen peroxide.

89. The process of claim 64, wherein the at least one oxidant is a peroxy acid.

90. The process of claim 89, wherein the peroxy acid is peracetic acid or meta-chloroperoxybenzoic acid.
